(19) United States
(12) Patent Application Publication
(10) Pub. No.: US 2020/0139792 A1
(43) Pub. Date: May 7, 2020

(54) VEHICLE RESIN PANEL AND VEHICLE

(71) Applicant: KABUSHIKI KAISHA TOYOTA JIDOSHOKKI, Kariya-shi, Aichi-ken (JP)

(72) Inventors: Masaki AGEMI, Kariya-shi (JP); Junya KATO, Kariya-shi (JP); Yusuke MATSUMOTO, Kariya-shi (JP)

(73) Assignee: KABUSHIKI KAISHA TOYOTA JIDOSHOKKI, Kariya-shi, Aichi-ken (JP)

(21) Appl. No.: 16/492,813

(22) PCT Filed: Feb. 21, 2018
(86) PCT No.: PCT/JP2018/006195

§ 371 Date: Sep. 10, 2019

(30) Foreign Application Priority Data
Mar. 13, 2017 (JP) 2017-047528

(51) Int. Cl. B60J 1/02; B60J 10/70

(52) U.S. Cl. CPC B60J 1/02; B60J 1/008; B60J 10/70

(57) ABSTRACT

The vehicle plastic panel according to the present invention configured so as to be attached to a window frame of a vehicle is provided with a non-transparent part which is a portion where a transparent resin-made first panel member and a transparent resin-made second panel member are superposed, a transparent part which is a portion of the first panel member on which the second panel member is not superposed, and a magnetizing body configured so as to be drawn by magnetic force together with a detachable member provided to a vehicle window mounting member. The non-transparent part is provided with a bonding part configured so as to be bonded to the window frame, and a visible part configured so as to be visible from inside the vehicle in a state in which the bonding part is bonded to the window frame. The magnetizing part is housed in the visible part.

### TECHNICAL FIELD

The present invention relates to a vehicle plastic panel and a vehicle.

### BACKGROUND

In some cases, window vehicle attachment members such as a sunshade and a dashboard camera are attached to and detached from a vehicle window such as a front window and a rear window of a vehicle. Each of these windows vehicle attachment members includes an attachment-detachment member, which is attached to and detached from the vehicle window. Patent Document 1 describes an example of a curtain including an adhesive disc serving as an attachment-detachment member. The curtain is attached to and detached from the vehicle window by the adhesive disc.

### PRIOR ART DOCUMENT

### Patent Document

Patent Document 1: Japanese Laid-Open Patent Publication No. 2003-112522

### SUMMARY OF THE INVENTION

### Problems that the Invention is to Solve

Deterioration of the attachment-detachment member lowers the force of the vehicle window attachment member acting on the vehicle window. This causes the vehicle window attachment member to be separated from the vehicle window.

It is an objective of the present invention to provide a vehicle plastic panel and a vehicle that prevent a vehicle window attachment member from being separated.

### Means for Solving the Problem

A vehicle plastic panel that solves the above-described problem is configured to be coupled to a window frame of a vehicle. The vehicle plastic panel includes an opaque portion where a first panel member and a second panel member are overlapped with each other, the first panel member being made of a transparent plastic, the second panel member being made of an opaque plastic, a transparent portion of the first panel member where the second panel member is not overlapped, and a magnetic attachment configured such that the magnetic object and an attachment-detachment member provided in a vehicle window attachment member are attracted to each other by a magnetic force. The opaque portion includes an adhesion portion configured to be bonded to the window frame and a visible portion configured to be viewed from a vehicle interior with the adhesion portion bonded to the window frame. The magnetic attachment is incorporated in the visible portion.

A vehicle that solves the above-described problem includes a vehicle body including a window frame that surrounds an opening, the vehicle plastic panel, and an adhesive that bonds the adhesion portion to the window frame such that the vehicle plastic panel is coupled to the window frame.

### BRIEF DESCRIPTION OF THE DRAWINGS

FIG. 1 is a front view showing a vehicle according to an embodiment.

FIG. 2 is a cross-sectional view taken along line 2-2 in FIG. 1, showing how the vehicle plastic panel is coupled to the vehicle body according to the embodiment.

FIG. 3A is a front view showing the vehicle plastic panel of FIG. 2 from a vehicle interior.

FIG. 3B is a partially enlarged view showing an overhang of the vehicle plastic panel shown in FIG. 3.

FIG. 4 is a cross-sectional view taken along line 4-4 in FIG. 3A, showing the magnet incorporated in the opaque portion.

FIG. 5 is a cross-sectional view showing a die used to manufacture the vehicle plastic panel of FIG. 2.

FIG. 6 is a diagram illustrating a process for attaching the vehicle window attachment member to the vehicle plastic panel of FIG. 2.

FIG. 7 is a diagram showing a method for manufacturing a vehicle plastic panel according to a modification.

### MODES FOR CARRYING OUT THE INVENTION

A vehicle plastic panel and a vehicle according to an embodiment will now be described.

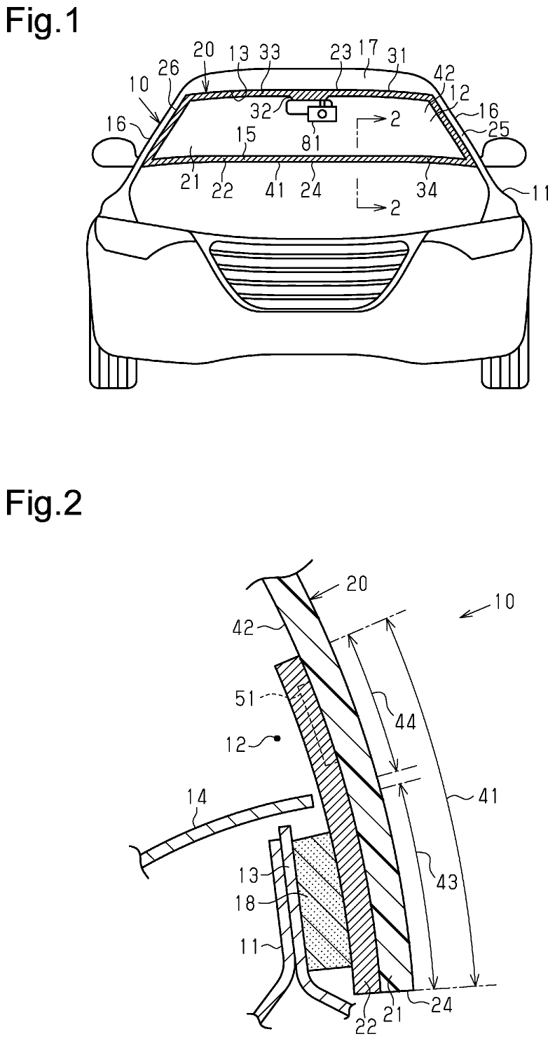

As shown in FIGS. 1 and 2, a vehicle 10 includes a vehicle body 11 and a vehicle plastic panel 20. The vehicle body 11 includes a window frame 13, which surrounds an opening 12, and an interior member 14, which is arranged in the vehicle interior. The window frame 13 is located at a front part of the vehicle body 11. More specifically, the window frame 13, which forms the periphery of the opening 12, is configured by a cowl panel 15, which configures part of the vehicle body 11, left and right front pillars 16, and a roof panel 17. The opening 12 and the window frame 13 are quadrilateral in a front view. The interior member 14 is fixed to the window frame 13 so as to cover the window frame 13, thereby preventing the window frame 13 from being viewed from the vehicle interior.

The vehicle 10 includes an adhesive 18, which bonds the vehicle plastic panel 20 to the window frame 13. Since the adhesive 18 bonds the vehicle plastic panel 20 to the outer side of the window frame 13, the vehicle plastic panel 20 configures a front window serving as a vehicle window. The front window is a fixed window that cannot be opened and closed.

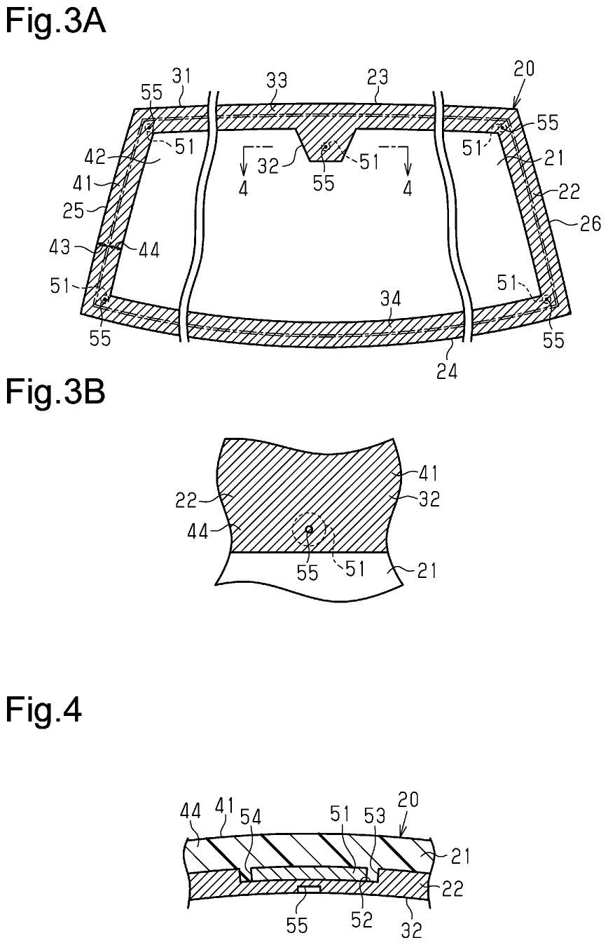

As shown in FIGS. 2, 3A, and 3B, the vehicle plastic panel 20 includes a transparent first panel member 21 and an opaque second panel member 22. The word “transparent” means that the transmittance of visible light defined by regulations and public announcement is satisfied. For example, in Japan, the transmittance of visible light defined by the Road Transport Vehicle Act or public announcement that defines particulars of the safety standard for road transport vehicles simply needs to be satisfied. The word “opaque” means that the transmittance of visible light is low as compared to the first panel member 21.

The first panel member 21 is made of a transparent plastic such as polycarbonate. The second panel member 22 is made of an opaque plastic in which a colored material is mixed with a transparent plastic such as polycarbonate. In the present embodiment, the second panel member 22 is manufactured from a plastic in which a black material such as carbon black is mixed with polycarbonate. The second panel member 22 is black.

The first panel member 21 has the form of a quadrilateral plate and is curved such that its central portion bulges outward. The first panel member 21 includes a periphery having a first edge 23, a second edge 24, a third edge 25, and a fourth edge 26. The second edge 24 and the third edge 25 are located at the side opposite from the first edge 23 and the fourth edge 26, respectively. The third edge 25 extends between one end of the first edge 23 and one end of the second edge 24, and the fourth edge 26 extends between the other end of the first edge 23 and the other end of the second edge 24. When the first panel member 21, which is coupled to the vehicle body 11, is seen from the vehicle interior, the first edge 23 is an upper edge, the second edge 24 is a lower edge, the third edge 25 is a left edge, and the fourth edge 26 is a right edge.

The second panel member 22 is located so as to be overlapped with one surface of the first panel member 21, more specifically, the inner surface of the first panel member 21. The second panel member 22 is overlapped with part of the first panel member 21. The second panel member 22 includes a quadrilateral frame 31, which is arranged along the periphery of the first panel member 21, and an overhang 32, which overhangs from the frame 31 toward the inner side of the frame 31. Portions of the frame 31 extending along the first edge 23 and the second edge 24 are a first frame edge 33 and a second frame edge 34, respectively. The overhang 32 overhangs from the first frame edge 33 toward the second frame edge 34. Further, the overhang 32 is located at the middle of the first frame edge 33 in the direction in which the first frame edge 33 extends.

The vehicle plastic panel 20 includes an opaque portion 41, where the first panel member 21 and the second panel member 22 are overlapped with each other, and a transparent portion 42, which is a portion of the first panel member 21 with which the second panel member 22 is not overlapped. The transparent portion 42 is configured only by the first panel member 21.

The vehicle plastic panel 20 is coupled to the vehicle body 11 such that the second panel member 22 is located inward from the first panel member 21. The window frame 13 faces the opaque portion 41, that is, the second panel member 22. The adhesive 18 is used to bond the opaque portion 41, that is, bond the second panel member 22, to the window frame 13.

As shown in FIG. 2, the opaque portion 41 includes an adhesion portion 43, which is bonded to the window frame 13, and a visible portion 44, which is visible from the vehicle interior with the adhesion portion 43 bonded to the window frame 13. The adhesion portion 43 is arranged outward from the adhesive 18, that is, the adhesive 18 is covered by the adhesion portion 43, which is opaque, from the vehicle exterior. Thus, the adhesive 18 is no longer visible from the vehicle exterior. The visible portion 44 overhangs further toward the transparent portion 42 than the interior member 14. The visible portion 44 is set so as not to interfere with the range of the field of view for the driver to check traffic conditions. For example, like in the present embodiment, it is preferred that the visible portion 44 be arranged only around the outer edge of the transparent portion 42.

As shown in FIGS. 3A and 4, the vehicle plastic panel 20 includes magnets 51, which are magnetic attachments. In the present embodiment, each of the four corners of the vehicle plastic panel 20 and the overhang 32 is equipped with one magnet 51. Each magnet 51 is arranged in the visible portion 44 of the opaque portion 41. Each magnet 51 is incorporated in the second panel member 22. The magnet 51 is a black permanent magnet. The magnet 51 may have any shape such as circle or polygon.

The second panel member 22 includes an accommodation portion 52, which is recessed in a surface that is in contact with the first panel member 21. The accommodation portion 52 includes an inner bottom surface and an inner circumferential surface 53, which intersects the outer edge of the inner bottom surface. The magnet 51 is accommodated in the accommodation portion 52. In the accommodation portion 52, the inner circumferential surface 53 is spaced apart from an outer circumferential surface 54 of the magnet 51, which is opposed to the inner circumferential surface 53. In the accommodation portion 52, part of the first panel member 21 is located between the inner circumferential surface 53 and the outer circumferential surface 54 of the magnet 51.

The entire magnet 51 is incorporated in the opaque portion 41 and is not exposed to the outside of the opaque portion 41. Further, since the magnet 51 is arranged in the accommodation portion 52, the opaque portion 41 has no projections. Thus, the opposite surfaces (inner surface and outer surface) of the opaque portion 41 are smooth.

The vehicle plastic panel 20 includes a mark 55, which indicates the position of each magnet 51. The mark 55 is arranged in the second panel member 22. The mark 55 of the present embodiment is a recess that is recessed toward the magnet 51 from the inner surface of the second panel member 22 and is visible from the vehicle interior.

The method for manufacturing the above-described vehicle plastic panel 20 will now be described. The vehicle plastic panel 20 is manufactured through two-color molding.

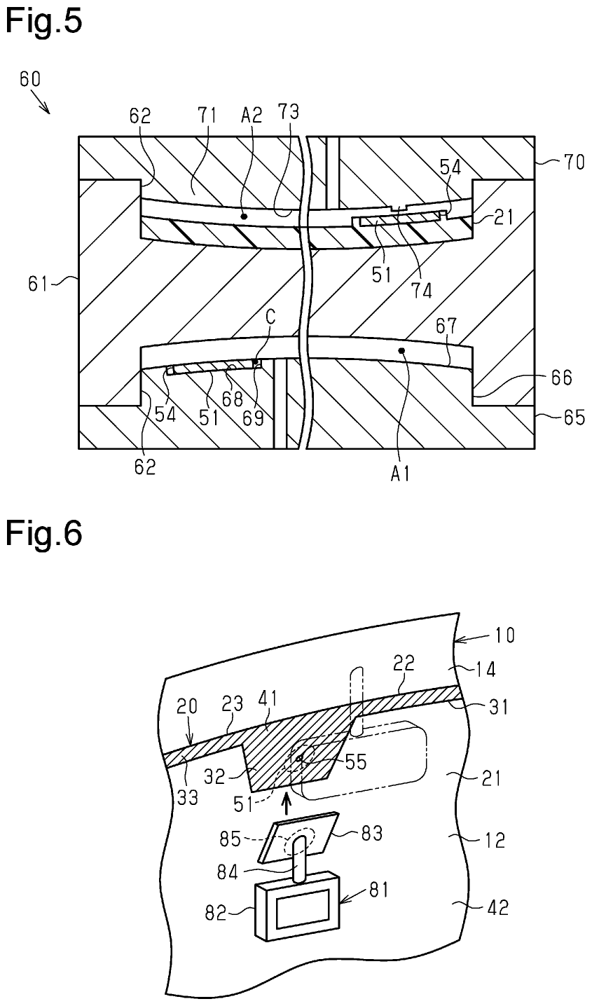

As shown in FIG. 5, a die 60, which is used for two-color molding, includes one inverse die 61 and two fixed dies 65 and 70. The inverse die 61 and the fixed dies 65 and 70 are manufactured by magnetic pieces (ferromagnetic pieces), for example, from a tool steel.

The inverse die 61 includes two recesses 62, which open toward the opposite sides. The two recesses 62 have the same shape. The two recesses 62 each include an inner bottom surface curved in a cross-sectional arcuate manner with the middle portion of the inner bottom surface further recessed. The inverse die 61 is driven by a driving mechanism (not shown) such that the positions of the two recesses 62 are inverted.

The fixed dies 65 and 70 include a first fixed die 65. The first fixed die 65 includes a first insertion portion 66, which is inserted into the recess 62 in a closed state. The first insertion portion 66 includes a first tip surface 67, which faces the inner bottom surface of the recess 62. The first insertion portion 66 includes an accommodation recess 68, which is recessed in the first tip surface 67. The number of the accommodation recesses 68 is the same as that of the magnets 51, which are provided in the vehicle plastic panel 20. Each magnet 51 is accommodated in the corresponding accommodation recess 68. The accommodation recess 68 includes an inner bottom surface and an accommodation circumferential surface 69, which extends between the inner bottom surface and the first tip surface 67. The magnet 51 is adsorbed to the first fixed die 65 (inner bottom surface of accommodation recess 68) by a magnetic force to prevent displacement of the magnet 51 in the accommodation recess 68. With the magnet 51 accommodated in the accommodation recess 68, a gap C is formed between the accommodation circumferential surface 69 and the outer circumferential surface 54 of the magnet 51. Inserting the first insertion portion 66 of the first fixed die 65 into the recess 62 with the magnet 51 accommodated in the accommodation recess 68 forms a space A1 in a region surrounded by the first insertion portion 66, the recess 62, and the magnet 51. The space A1 has the same shape as the first panel member 21. When the vehicle plastic panel 20 is manufactured, the space A1 is filled with molten resin, of which the first panel member 21 is made. When the molten resin hardens, the first panel member 21 is molded. Further, when the molten resin hardens, the magnet 51 is attached to the first panel member 21 and integrated with the first panel member 21. Driving the driving mechanism (not shown) causes the first insertion portion 66 to be inserted into the recess 62 and to be detached from the recess 62.

The fixed dies 65 and 70 include a second fixed die 70, which is different from the first fixed die 65. The second fixed die 70 includes a second insertion portion 71, which is inserted into the recess 62 in a closed state. When the second insertion portion 71 is inserted into the recess 62, the molded first panel member 21, which has been molded, is arranged on the inner bottom surface of the recess 62. The second insertion portion 71 includes a second tip surface 73, which faces the inner bottom surface of the recess 62. The second fixed die 70 includes a projection 74, which projects from the second tip surface 73. The projection 74 is located at a position facing the magnet 51 integrated with the first panel member 21, which is arranged along the inner bottom surface of the recess 62. Inserting the second insertion portion 71 of the second fixed die 70 into the recess 62 forms a space A2 in a region surrounded by the second insertion portion 71, the recess 62, the first panel member 21, and the magnet 51. The space A2 has the same shape as the second panel member 22. When the vehicle plastic panel 20 is manufactured, the space A2 is filled with molten resin, of which the second panel member 22 is made. When the molten resin hardens, the second panel member 22 is molded. Thus, the vehicle plastic panel 20 equipped with the magnets 51 is manufactured through insert-molding. Driving the driving mechanism (not shown) causes the second insertion portion 71 to be inserted into the recess 62 and to be detached from the recess 62.

The operation of the vehicle plastic panel 20 and the vehicle 10 of the present embodiment will now be described.

A vehicle window attachment member such as a dashboard camera or a sunshade is attached to and detached from the vehicle plastic panel 20. The vehicle window attachment member is attached and detached using the magnets 51.

As shown in FIG. 6, a dashboard camera 81 can be attached to the vehicle plastic panel 20 by a magnetic force of the magnet 51 incorporated in the overhang 32. The dashboard camera 81 includes an imaging device 82, which images the front of the vehicle 10, and an attachment-detachment portion 83, which is used to attach the imaging device 82 to the vehicle plastic panel 20 and detach the imaging device 82 from the vehicle plastic panel 20. The attachment-detachment portion 83 includes a handle 84 and an attachment member magnetic attachment 85. A first end of the handle 84 is fixed to the imaging device 82, and the attachment member magnetic attachment 85 is coupled to the second end of the handle 84. The attachment member magnetic attachment 85, which serves as an attachment-detachment member, is a permanent magnet or a magnetic piece (ferromagnetic piece).

To attach the dashboard camera 81, the attachment member magnetic attachment 85 is moved toward the overhang 32. Even if the magnet 51 is not visible from the vehicle interior, viewing of the mark 55 allows the attachment member magnetic attachment 85 to be moved toward the attachment member magnetic attachment 85. The attachment member magnetic attachment 85 and the magnet 51 are attracted toward each other by a magnetic force. This allows the dashboard camera 81 to be attached to the vehicle plastic panel 20.

To detach the dashboard camera 81 from the vehicle plastic panel 20, the dashboard camera 81 is pulled to separate the dashboard camera 81 from the overhang 32.

The sunshade (not shown) can be attached to the vehicle plastic panel 20 using magnetic forces of the magnets 51 at the four corners of the vehicle plastic panel 20. The sunshade includes the attachment member magnetic attachment 85. The attachment member magnetic attachment 85 and the magnet 51 are attracted toward each other by a magnetic force. The sunshade is attached to the vehicle plastic panel 20 only while the vehicle 10 is not travelling and is detached from the vehicle plastic panel 20 while the vehicle 10 is travelling.

Thus, the above-described embodiment has the following advantages.

(1) When the vehicle window attachment member is attached to the vehicle plastic panel 20 using an adhesive disc, the attachment and detachment causes the adhesive disc to be microscopically damaged and causes microscopic foreign matter such as dust to collect on the adhesive disc. Damage and foreign matter worsen the airtightness of the portion where the adhesive disc is adsorbed to the vehicle plastic panel 20, thereby lowering the adsorption force of the adhesive disc. When the vehicle window attachment member is attached using a tape, the attachment and detachment lowers the adhesive force.

The magnetic force of the magnet 51 is not lowered easily by the attachment and detachment of the vehicle window attachment member. Thus, even if the magnet 51 is used for a long period of time, the force of holding the vehicle window attachment member on the vehicle plastic panel 20 is easily retained. This prevents the vehicle window attachment member from being separated from the vehicle plastic panel 20.

The magnet 51 is incorporated in the visible portion 44, which is part of the opaque portion 41. Thus, when the vehicle 10 is seen from the vehicle exterior, the opaque portion 41 and the magnet 51 are overlapped. In this case, the magnet 51 is difficult to view. Accordingly, the influence on the appearance caused by the incorporation of the magnet 51 is reduced.

(2) The vehicle window attachment member can be attached to and detached from the vehicle plastic panel 20 by a magnetic force of the magnet 51. Thus, as compared to when the vehicle window attachment member is attached to and detached from the vehicle plastic panel 20 using an adhesive disc or tape, the vehicle plastic panel 20 has a high resistance to dirt.

(3) When the vehicle window is a glass, it is difficult to incorporate the magnet 51 in the vehicle window. In contrast, when the vehicle window is the vehicle plastic panel 20, the magnet 51 can be easily incorporated in the vehicle window through insert-molding.

(4) The magnet 51 is incorporated in the second panel member 22. The second panel member 22, which is opaque, is equipped with the magnet 51. This makes the magnet 51 unnoticeable in the second panel member 22. As compared to when the magnet 51 is incorporated in the portion of the first panel member 21 configuring the opaque portion 41, the magnet 51 has a low visibility from the vehicle exterior of the vehicle. Particularly, when the vehicle the plastic panel 20 is seen from the side of the vehicle 10, the magnet 51 incorporated in the second panel member 22 is difficult to view.

(5) The magnet 51 is incorporated in the second panel member 22. In this case, the magnet 51 can be moved further toward the passenger compartment as compared to when the magnet 51 is incorporated in the first panel member 21. This allows the attachment member magnetic attachment 85 attached from the vehicle interior to be moved toward the magnet 51 as much as possible and increases the force of holding the vehicle plastic panel 20 on the vehicle window attachment member.

(6) The mark 55 is arranged. Thus, even if the magnet 51 is not visible from the vehicle interior, the position of the magnet 51 is recognizable. This facilitates attachment of the vehicle window attachment member.

(7) The magnet 51 is used as a magnetic attachment. Thus, whether the attachment member magnetic attachment 85 is a magnetic piece or a permanent magnet, the vehicle window attachment member can be attached to the vehicle plastic panel 20.

(8) Part of the first panel member 21 is located between the inner circumferential surface 53 and the outer circumferential surface 54 of the magnet 51. This increases the contact area of the magnet 51 and the first panel member 21 and thus improves the force of the first panel member 21 holding the magnet 51. Thus, when the vehicle plastic panel 20 is manufactured, the separation of the magnet 51 from the first panel member 21 is limited even before the second panel member 22 is molded.

The embodiment may be modified as follows.

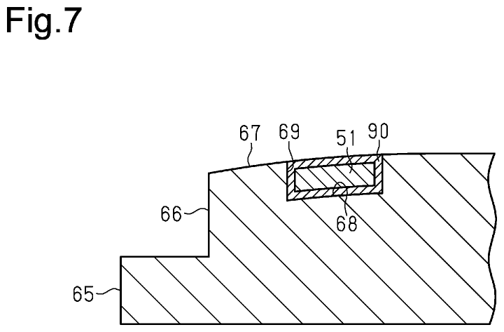

As shown in FIG. 7, when the vehicle plastic panel 20 is manufactured, the magnet 51 may be accommodated in the accommodation recess 68 with the magnet 51 coated by a plastic 90, which has the same type of color as the second panel member 22. In this case, the end surface of the magnet 51 is difficult to see. This limits influence on the appearance.

To manufacture the vehicle plastic panel 20, the first panel member 21 may be molded so as to be overlapped with the second panel member 22 after the second panel member 22 is molded. In this case, to form the second panel member 22, the magnets 51 are arranged on the tip surfaces of the fixed dies 65 and 70. This allows for insert-molding such that the magnet 51 is incorporated in the second panel member 22.

The mark 55 does not need to be a recess. Instead, for example, a different member that allows the mark 55 to be viewed from the vehicle interior may be arranged at the position of the mark 55.

The mark 55 does not need to be in line with the magnet 51 in the thickness direction of the vehicle plastic panel 20. Instead, the mark 55 may be arranged at a position that is slightly deviated from the magnet 51 (for example, along the outer edge of the magnet 51).

The vehicle plastic panel 20 does not have to include the mark 55.

The magnet 51 may be incorporated in the first panel member 21. In this case, the first fixed die 65 does not include the accommodation recess 68. To manufacture the vehicle plastic panel 20, the magnet 51 is placed on the first tip surface 67 of the first insertion portion 66. In this state, the space A1, which is defined by the first insertion portion 66 and the recess 62, is filled with resin, of which the first insertion portion 66 is made. In this case, insert-molding is performed to mold the first panel member 21 in which the magnet 51 is incorporated.

In the embodiment, the visible portions 44 are arranged at portions other than where the magnets 51 are arranged. Instead, the visible portions 44 may be arranged only at the portions where the magnets 51 are arranged. For example, when the magnets 51 are arranged only at the four corners of the vehicle plastic panel 20, the visible portions 44 may be arranged only at the four corners.

A magnetic piece (ferromagnetic piece) may be used as a magnetic attachment. That is, metals (for example, iron) that are attracted to each other with the magnetic force of a permanent magnet may be used as magnetic attachments. In this case, when the entire magnetic piece is incorporated in the vehicle plastic panel 20 and portions of the magnetic piece exposed to the outside of the vehicle plastic panel 20 are eliminated, the magnetic piece is not exposed to external air. This limits deterioration of a magnetic piece such as rust.

The number of magnetic attachments may be changed and may be one or more.

When multiple magnetic attachments are arranged, the magnets 51 and the magnetic attachments may be arranged in a mixed manner.

As long as the vehicle plastic panel 20 is a vehicle window arranged as a fixed window such as a rear window or quarter window, the vehicle plastic panel 20 may be used as any vehicle window. In some cases, the vehicle window has a different transmittance of visible light that has to be satisfied (transmittance of visible light defined by regulations or public announcement) depending on the position of the vehicle window. Thus, in some cases, the definition of the term “transparent” differs depending on the position of the vehicle window.

The second panel member 22 does not have to be black. In this case, it is preferred that the color of the magnet 51 be set to the same type of color painting.

The magnet 51 may be incorporated in the visible portion 44 such that the end surface of the magnet 51 is visible from the vehicle interior or the vehicle exterior.

As long as the vehicle window attachment member can be attached to the vehicle window and has a magnetic attachment, the vehicle window attachment member may be any object, for example, a beginner driver sign, an aged driver sign, and a safe drive charm. These vehicle window attachment members can be attached to the vehicle plastic panel 20, which is used as a rear window or quarter window.

1. A vehicle plastic panel configured to be coupled to a window frame of a vehicle, the vehicle plastic panel comprising:
an opaque portion where a first panel member and a second panel member are overlapped with each other, the first panel member being made of a transparent plastic, the second panel member being made of an opaque plastic;
a transparent portion of the first panel member with which the second panel member is not overlapped; and
a magnetic attachment configured such that the magnetic attachment and an attachment-detachment member provided in a vehicle window attachment member are attracted to each other by a magnetic force, wherein the opaque portion includes an adhesion portion configured to be bonded to the window frame and a visible portion configured to be visible from a vehicle interior with the adhesion portion bonded to the window frame, and
the magnetic attachment is incorporated in the visible portion.

2. The vehicle plastic panel according to claim 1, wherein the magnetic attachment is incorporated in the second panel member.

3. The vehicle plastic panel according to claim 1, comprising a mark indicating a position of the magnetic attachment.

4. A vehicle comprising:
a vehicle body including a window frame that surrounds an opening;
the vehicle plastic panel according to claim 1; and
an adhesive that bonds the adhesion portion to the window frame such that the vehicle plastic panel is coupled to the window frame.
